(19) United States
(12) Patent Application Publication
(10) Pub. No.: US 2019/0108112 A1
(43) Pub. Date: Apr. 11, 2019

(54) SYSTEM AND METHOD FOR GENERATING A LOG ANALYSIS REPORT FROM A SET OF DATA SOURCES

(71) Applicant: HCL Technologies Limited, Noida (IN)

(72) Inventors: Arun Kumar KANNAN, Chennai (IN); Rafeyudeen KAMAL BATCHA, Chennai (IN)

(21) Appl. No.: 15/853,577

(22) Filed: Dec. 22, 2017

(30) Foreign Application Priority Data
Oct. 5, 2017 (IN) 201711035325

(51) Int. Cl. G06F 11/30; G06F 11/34; G06T 11/20

(52) U.S. Cl. CPC G06F 11/3086; G06T 11/206; G06F 11/3476; G06F 11/3068

(57) ABSTRACT

Disclosed is a log analysis tool for generating a log analysis report upon analyzing log data received from a set of log data sources. An input module receives one or more input files from a set of log data sources. A parser module parses the plurality of logs into a plurality of parsed logs in a recursive manner. The plurality of logs may be parsed to merge the plurality of parsed logs in a format selected by a user. A filtering module filters the plurality of parsed logs based on a search criterion, specified by the user. The filtering module further classifies the subset upon color coding each log of the log subset based on a subset of the set of predefined parameters. An output module displays the subset, based on the classification of the log subset, in at least one visualization format.

### CROSS REFERENCE TO RELATED APPLICATIONS

The present application claims priority from Indian Patent Application No: 201711035325 filed on 5 Oct., 2017 the entirety of which is hereby incorporated by reference.

### TECHNICAL FIELD

The present subject matter described herein, in general, relates to generate a log analysis report. More specifically, a method for generating the log analysis report upon analyzing log data captured from a set of log data sources.

### BACKGROUND

In an era of Information Technology (IT) and automation, it becomes utmost import to capture log data pertaining to each activity being performed on an IT enabled or automated system. It may be noted that the log data may be collected, or logged, and logged data and messages (also known as logs) may be emitted by network devices, operating systems, and applications, among others. This log data may be analyzed to help an in locating bug(s) being encountered in the IT enabled solution. Additionally, the log data may be analyzed and used in a variety of scenarios including, for example, security analysis, information technology (IT) performance management, debugging, troubleshooting, and network management, among others.

With the continuous stream of data being generated by the IT system, an enormous amount of log data is being generated at the backend. Hence it becomes cumbersome for the conventional log analysis systems to analyze the amount of log data and draw inferences from it.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for generating a log analysis report upon analyzing log data captured from a set of log data sources and the concepts are further described below in the detailed description. This summary is not intended to identify essential features of the claimed subject matter nor is it intended for use in limiting the scope of the claimed subject matter.

In one implementation, a log analysis tool for generating a log analysis report upon analyzing log data received from a set of log data sources is disclosed. The log analysis tool may comprise a processor and a memory coupled to the processor. The processor may execute a plurality of modules present in the memory. The plurality of modules may comprise an input module, a parser module, a filtering module, and an output module. The input module may receive one or more input files from a set of log data sources. In one aspect, each input file may comprise a plurality of logs. The parser module may parse the plurality of logs into a plurality of parsed logs in a recursive manner. The plurality of logs may be parsed to merge the plurality of parsed logs in a format selected by a user. The filtering module may filter the plurality of parsed logs based on a search criterion, specified by the user. In one aspect, the plurality of parsed logs may be filtered to display a subset of the plurality of parsed logs. In one aspect, the search criterion may comprise a set of predefined parameters. The filtering module may further classify the subset upon color coding each log of the subset based on one or more predefined parameters selected from the set of predefined parameters. The output module may display the subset, based on the classification, in at least one visualization format thereby generating a log analysis report upon analyzing log data received from the set of log data sources.

In another implementation, a method for generating a log analysis report upon analyzing log data received from a set of log data sources is disclosed. In order to generate the log analysis report, initially, one or more input files may be received from a set of log data sources. In one aspect, each input file may comprise a plurality of logs. Upon receiving the one or more input files, the plurality of logs may be parsed into a plurality of parsed logs in a recursive manner. The plurality of logs may be parsed to merge the plurality of parsed logs in a format selected by a user. Upon parsing, the plurality of parsed logs may be filtered based on a search criterion, specified by the user. In one aspect, the plurality of parsed logs may be filtered to display a subset of the plurality of parsed logs. In one aspect, the search criterion may comprise a set of predefined parameters. Subsequent to the filtration of plurality of logs, the subset may be classified upon color coding each log of the subset based on one or more predefined parameters selected from the set of predefined parameters. Post classification of the subset, the subset may be displayed, based on the classification, in at least one visualization format thereby generating a log analysis report upon analyzing log data captured from the set of log data sources. In one aspect, the aforementioned method for generating the log analysis report may be performed by a processor using programmed instructions stored in a memory of the system.

In yet another implementation, non-transitory computer readable medium embodying a program executable in a computing device for generating a log analysis report upon analyzing log data received from a set of log data sources is disclosed. The program may comprise a program code for receiving one or more input files from a set of log data sources, wherein each input file comprises a plurality of logs. The program may further comprise a program code for parsing the plurality of logs into a plurality of parsed logs in a recursive manner, wherein the plurality of logs is parsed to merge the plurality of parsed logs in a format selected by a user. The program may further comprise a program code for filtering the plurality of parsed logs based on a search criterion, specified by the user, wherein the plurality of parsed logs is filtered to display a subset of the plurality of parsed logs, and wherein the search criterion comprises a set of predefined parameters. The program may further comprise a program code for classifying the subset upon color coding each log of the subset based on one or more predefined parameters selected from the set of predefined parameters. The program may further comprise a program code for displaying the subset, based on the classification, in at least one visualization format thereby generating a log analysis report upon analyzing log data captured from the set of log data sources.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a log analysis tool for generating a log analysis report upon analyzing log data received from a set of log data sources, in accordance with an embodiment of the present subject matter.

FIG. 2 illustrates the log analysis tool, in accordance with an embodiment of the present subject matter.

FIGS. 3 to 7 illustrate various embodiments of the log analysis tool for generating the log analysis report.

FIG. 8 illustrates a method for generating the log analysis report upon analyzing log data received from a set of log data sources, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The proposed invention facilitates a log analyzer tool and a method to generate a log analysis report upon analyzing log data received from a set of log data sources is disclosed. It may be understood that each log data source comprises log data. In other words, the log analyzer tool provides a Graphical User Interface (GUI) enabling the user to perform log analysis process on input files received from the set of log data sources and performing various actions thereof. It may be understood that each input file may have a distinct data format from another input file and comprises a plurality of logs.

To analyse the log data received from distinct log data source, the log analyzer tool facilitates a user friendly manner of analysing the log data by receiving the input files. Upon receipt of the input files, the plurality of logs may be parsed into a plurality of parsed logs in a recursive manner. The plurality of logs may be parsed to merge the plurality of parsed logs in a format selected by a user. Upon parsing, the plurality of parsed logs may be filtered based on a search criterion, specified by the user.

In one aspect, the plurality of parsed logs may be filtered to display a subset of the plurality of parsed logs. Subsequent to the filtration of plurality of logs, the subset may be classified upon color coding each log of the log subset. Post classification of the subset, the subset may be displayed in at least one visualization format thereby generating a log analysis report. Based on the above, it may be noted that the log analysis tool has the capability to process any log and thereby visualize the log to the user in a format specified by the user such as Grid view, Report view, and Analysis view. It may be understood that from the log analysis report visualized in the one of the formats as aforementioned, the user may easily locate a log indicating an error/bug encountered in an IT enabled system proactively take necessary measures to rectify such error/bug.

In addition to the generation of the log analysis report, the log analysis tool further displays detail description of each log, present in the one or more input files, to the user. Further the log analysis tool has the capability to combine all the logs, received from distinct data sources, and based on integrated time sequences associated to each log. Thus, the log analysis tool facilitates the user to analyse the log data as per his/her requirements and draw inferences from such log data.

While aspects of described system and method for generating a log analysis report upon analyzing log data received from a set of log data sources may be implemented in any number of different computing systems, environments, and/or configurations, the embodiments are described in the context of the following exemplary log analysis tool.

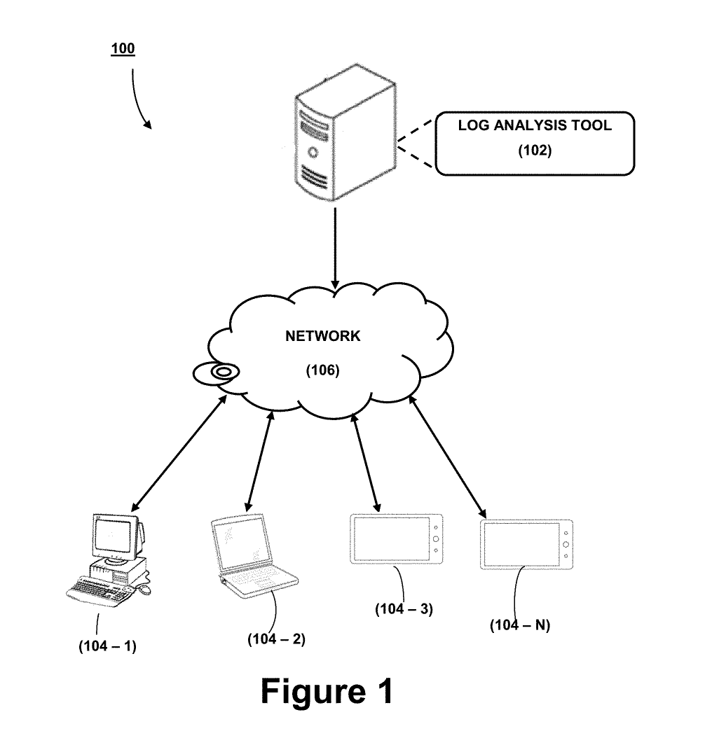

Referring now to FIG. 1, a network implementation 100 of a log analysis tool 102 for generating a log analysis report upon analyzing log data received from a set of log data sources is disclosed. In order to generate the log analysis report, initially, the log analysis tool 102 receives one or more input files from a set of log data sources. In one aspect, each input file may comprise a plurality of logs. Upon receiving the one or more input files, the log analysis tool 102 parses the plurality of logs into a plurality of parsed logs in a recursive manner. The plurality of logs may be parsed to merge the plurality of parsed logs in a format selected by a user. Upon parsing, the log analysis tool 102 filters the plurality of parsed logs based on a search criterion, specified by the user. In one aspect, the plurality of parsed logs may be filtered to display a subset of the plurality of parsed logs. Subsequent to the filtration of plurality of logs, the log analysis tool 102 classifies the subset upon color coding each log of the subset based on one or more predefined parameters selected from the set of predefined parameters. Post classification of the subset, the log analysis tool 102 displays the subset, based on the classification, in at least one visualization format thereby generating a log analysis report upon analyzing log data received from the set of log data sources.

Although the present disclosure is explained considering that the log analysis tool 102 is implemented on a server, it may be understood that the log analysis tool 102 may be implemented in a variety of computing systems, such as a laptop computer, a desktop computer, a notebook, a workstation, a mainframe computer, a server, a network server, a cloud-based computing environment. It will be understood that the log analysis tool 102 may be accessed by multiple users through one or more user devices 104-1, 104-2 . . . 104-N, collectively referred to as user 104 or stakeholders, hereinafter, or applications residing on the user devices 104. In one implementation, the log analysis tool 102 may comprise the cloud-based computing environment in which a user may operate individual computing systems configured to execute remotely located applications. Examples of the user devices 104 may include, but are not limited to, a IoT device, IoT gateway, portable computer, a personal digital assistant, a handheld device, and a workstation. The user devices 104 are communicatively coupled to the log analysis tool 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Hypertext Transfer Protocol Secure (HTTPS), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

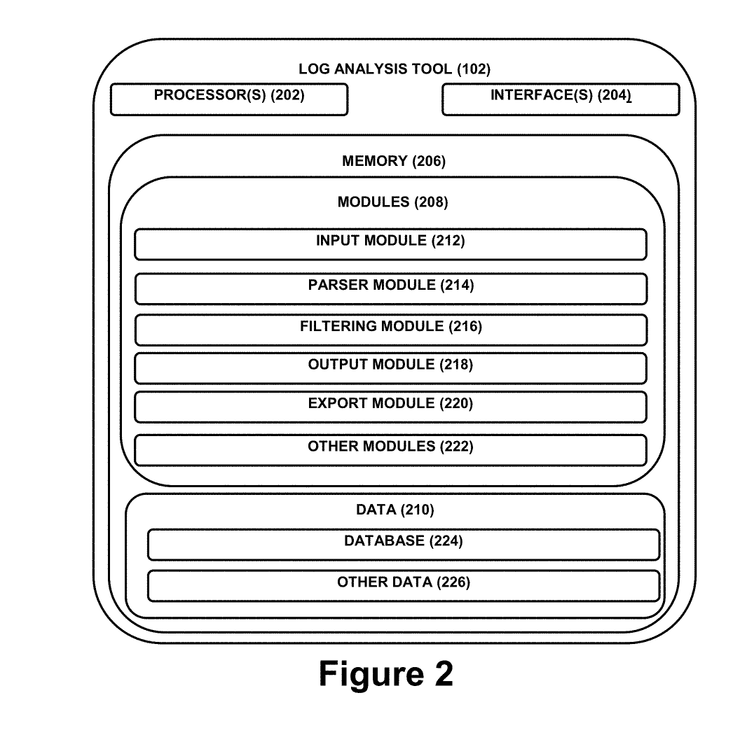

Referring now to FIG. 2, the log analysis tool 102 is illustrated in accordance with an embodiment of the present subject matter. In one embodiment, the log analysis tool 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the log analysis tool 102 to interact with the user directly or through the user devices 104. Further, the I/O interface 204 may enable the log analysis tool 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include an input module 212, a parser module 214, a filtering module 216, an output module 218, an export module 220, and other modules 222. The other modules 222 may include programs or coded instructions that supplement applications and functions of the log analysis tool 102. The modules 208 described herein may be implemented as software modules that may be executed in the cloud-based computing environment of the log analysis tool 102.

The data 210, amongst other things, serves as a repository for storing data processed, received, and generated by one or more of the modules 208. The data 210 may also include a database 224 and other data 226. The other data 226 may include data generated as a result of the execution of one or more modules in the other modules 222.

As there are various challenges observed in the existing art, the challenges necessitate the need to build the log analysis tool 102 for generating a log analysis report upon analyzing log data captured from a set of log data sources. In order to generate the log analysis report, at first, a user may use the user device 104 to access the log analysis tool 102 via the I/O interface 204. The user may register them using the I/O interface 204 to use the log analysis tool 102. In one aspect, the user may access the I/O interface 204 of the log analysis tool 102. To generate the log analysis report, the log analysis tool 102 may employ the input module 212, the parser module 214, the filtering module 216, the output module 218, and the export module 220. The detail functioning of the modules is described below with the help of figures.

To generate the log analysis report, initially, the input module 212 receives one or more input files from a set of log data sources. It may be understood that each input file may comprise a plurality of logs comprising log data that may be associated to Linux/Kernel. In one aspect, the input file may be associated to one of the file format comprising an eXtensible Markup Language (XML) file, a JavaScript Object Notation (JSON) file, a LOG file, and a Flat file. In order to input the one or more input files, the user selects each input file from a specific location, of the memory 206, storing an input file. Subsequent to the selection, the input module 212 uploads each input file onto the log analysis tool 102 for further processing and analysis. On the other hand, the input module 212 fails to upload each input file and prompts a message to the user “Invalid Log File”, when the input file is not a valid log file. During such instance, the input module 212 displays an input file, determined as invalid, onto a separate a display panel for the user's reference.

Once each input file is uploaded, the parser module 214 parses the plurality of logs into a plurality of parsed logs. In one embodiment, the plurality of logs may be parsed in a recursive manner. It may be understood that the plurality of logs may be parsed in the recursive manner in two ways. In one implementation, if the user selects a log directory as an input path, the log analysis tool 102 recursively copies the plurality of parsed logs to all sub directories in order to check on the one or more input files and thereby parses each input file. In another implementation, if the log analysis tool 102 receives the one or more input files, as compressed file, the log analysis tool 102 parses each input file in recursive manner. In one aspect, the plurality of logs may be parsed to merge the plurality of parsed logs in a format selected by a user. Subsequent to the parsing, the filtering module 216 filters the plurality of parsed logs based on a search criterion specified by the user. In one aspect, the plurality of parsed logs may be filtered to display a subset of the plurality of parsed logs to the user on a display unit of the user device 104. In one embodiment, the search criterion may comprise a set of predefined parameters including, but not limited to, Date, Message, Number of Occurrences, Duplicate Occurrences, Severity Type, And File Name. In one example, the Severity Type is one of ‘Severe’ and ‘Warning’. In addition to the above, the plurality of parsed logs may further be filtered based on regular expressions based on a combination of special/wildcard characters, numerals, and alphabets.

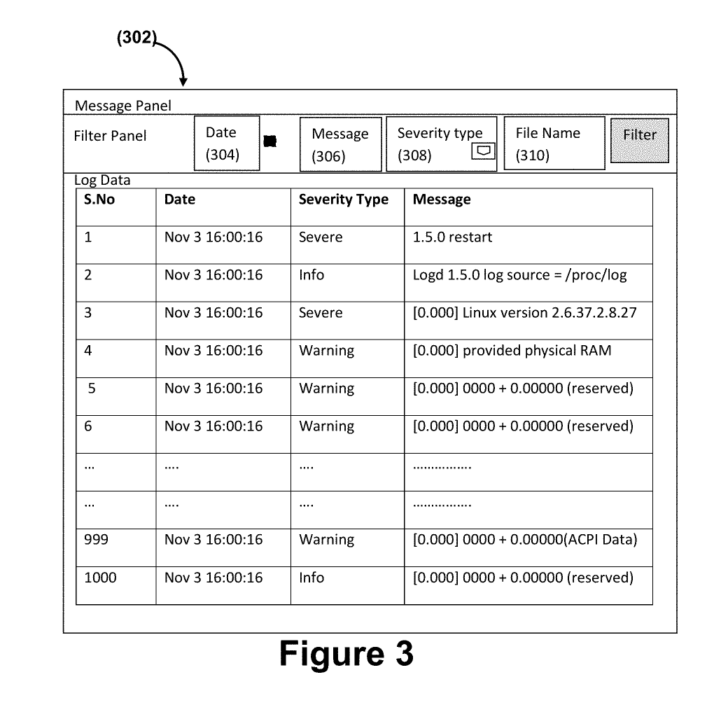

Referring to FIG. 3. In order to elucidate the functioning of the filtering module 216, consider an example (1) where the filtering module 216 facilitates the user to filter the plurality of parsed logs based on the set of predefined parameters. As shown in the FIG. 3, the plurality of parsed logs numbered 1-1000 is displayed, along with the filtering options, on a display page 302 to the user. On the display page 302, the filtering options shown above the list of the plurality of parsed logs numbered 1-1000, facilitates the user to filter the plurality of parsed logs. As shown in the figure, the filtering options includes Date 304, Message 306, Severity Type 308, and File Name 310. However, the filtering options may also include Number of Occurrences (not shown in the figure) and Duplicate occurrences (not shown in the figure). In this example, as shown in the FIG. 3, the user has filtered the plurality of parsed logs based on ‘Date’ as all the logs being displayed to the user having date as ‘Nov 3’.

After filtration of the plurality of parsed logs, the filtering module 216 further classifies the subset upon color coding each log of the subset based on one or more predefined parameters selected from the set of predefined parameters. In an exemplary embodiment of the invention, the filtering module 216 code logs, with a color ‘Red’, having severity type as ‘Severe’. Similarly, the filtering module 216 code logs, with a color ‘Amber’, having severity type as ‘Warning’. Likewise, the filtering module 216 code logs having any other severity type defined by the user with a distinct color so as to facilitate the user in locating such logs amongst the plurality of parsed logs with ease. Upon color the subset with a specific color, the filtering module 216 classifies the subset in accordance with the color coding.

Post classification of the subset, the output module 218 displays the subset, based on the classification, in at least one visualization format. Examples of the at least one visualization format may include, but not limited to, a grid view, an analyzer view, and a report view.

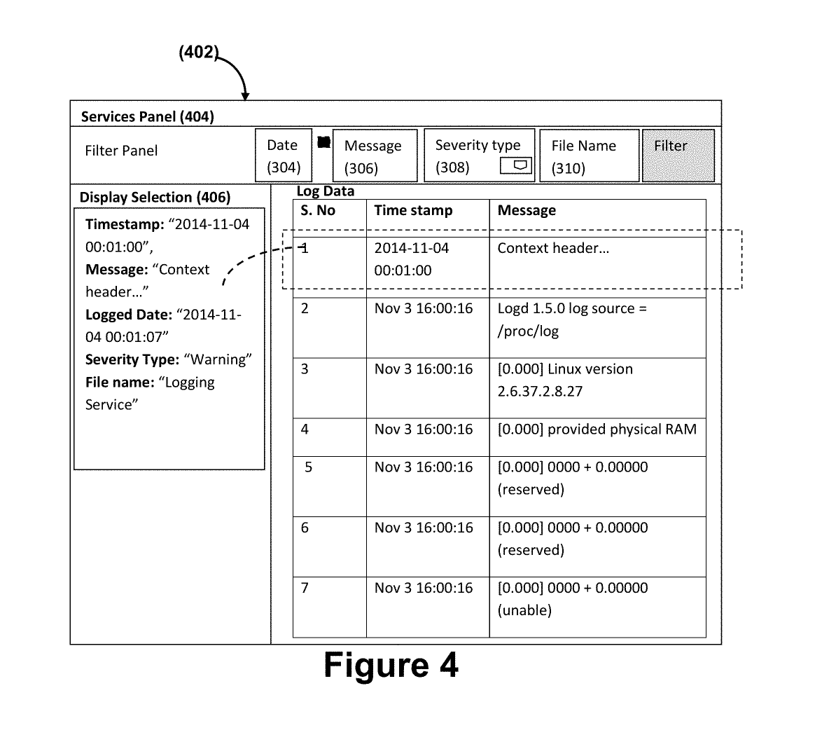

In one aspect, the grid view illustrate logs classified in distinct categories and also displays a message associated to an individual log of the subset. In other words, the output module 218 displays metadata associated to a log selected from the subset. The metadata indicates Timestamp, Message, Source File of the Log, Logged Date, Log Type, Device Name, and File Name. In one example, a grid view page 402 illustrating the metadata associated to a log is shown in FIG. 4. As shown in the figure, the grid view comprises two panels i.e. a Services Panel 404 and a Display Selection 404. The Services Panel 404 displays the subset of the plurality of parsed logs, as filtered by the user. Upon selecting a log amongst 7 logs, the output module 218 displays the metadata associated to the log, selected, in the Display Selection 406. In this example, the user selects or hovers over the first log (i.e. S. No ‘1’) of the list upon which the output module 218 displays Timestamp: “2014-11-04 00:01:00”, Message: “Context header . . . ”, Logged Date: “2014-11-04 00:01:07”, Severity Type: “Warning”, File name: “Logging Service”.

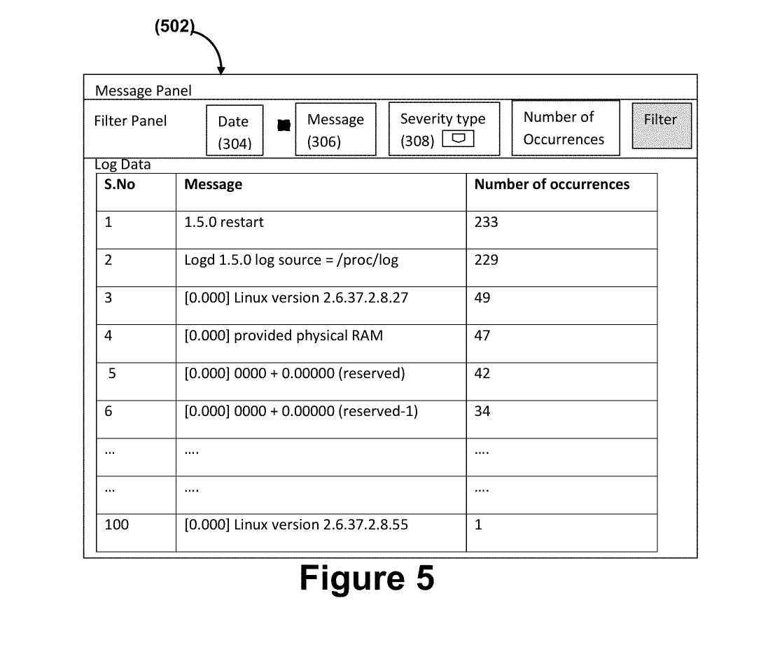

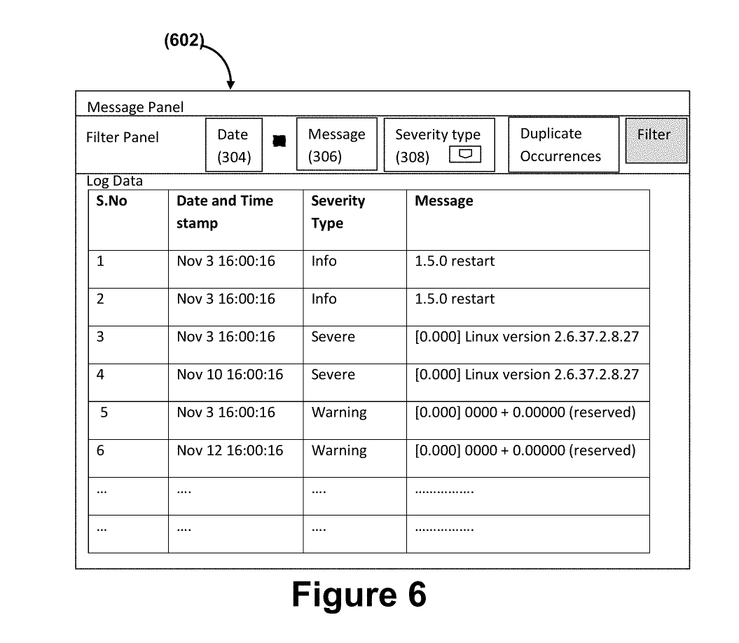

Referring to FIG. 5. In addition to the above, considering the example (1) same as aforementioned wherein the output module 218 displays a page 502 comprising a list in an ascending order of ‘Number of Occurrences’ associated to the logs, when the plurality of parsed logs numbered 1-1000 is filtered based on the number of occurrences 306. It may be noted that the output module 218 displays the logs having ‘Number of Occurrences’ greater than ‘1’. Referring to FIG. 6. Similar to the filtration, as aforementioned, the output module 218 filters the plurality of parsed logs numbered 1-1000 based on ‘Duplicate Occurrences’ 308 on a page 602. The output module 218 may then display a list of ‘Duplicate Occurrences’ of the logs on page 602, as shown in the FIG. 6.

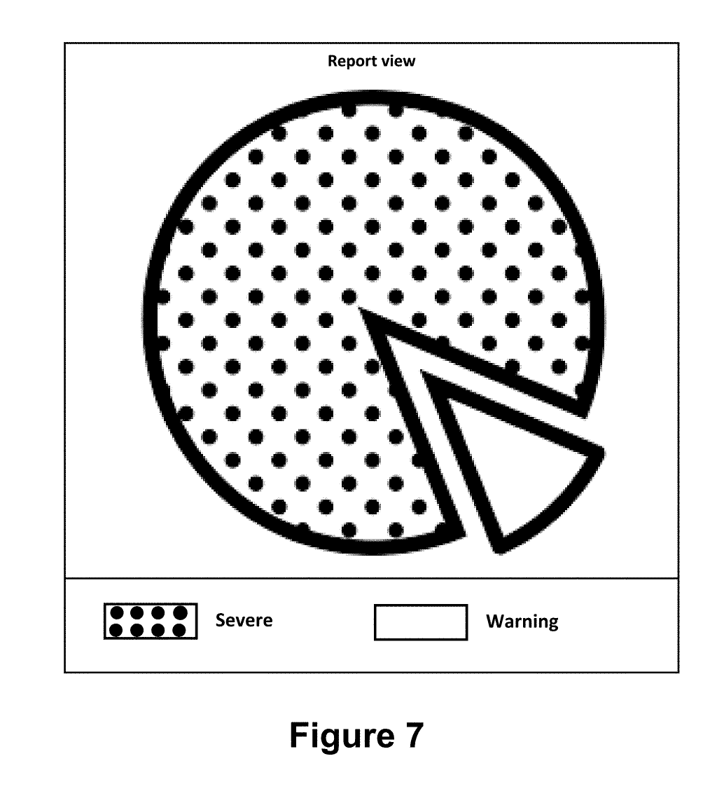

The report view, on the other hand, previews a dashboard view of log analysis along with at least one of a pie chart and a bar chart. Referring to FIG. 7. In this example, the output module 218 displays a pictorial representation of the subset in a pie chart. As shown in the figure, the pie chart illustrates the classification of logs based on ‘Severity Type’. In this example, logs assigned with Severity Type as ‘Severe’ is substantially greater than logs assigned with severity type as “Warning”. The Severity Type ‘Severe’ and ‘Warning’ categories are based on the log specific messages; the user may have an option to categorizes them based on the search criteria.

In one embodiment, the log analysis tool 102 further comprises an export module 220 for exporting the subset to at least one file format. In one aspect, the at least one file format may indicate the log analysis report, upon receipt of an export request from the user. Examples of the at least one file format may include, but not limited to, an XLS file, an XML file, and a DOC file. Thus, based on the above, the log analysis tool 102 facilitates to analyse the plurality of logs, received from the set of log data sources, and thereby visualize the subset, of the plurality of logs, in at least one format so as to assist the user in locating a log indicating an error/bug encountered in an IT enabled system and thereby proactively take necessary measures to rectify such error.

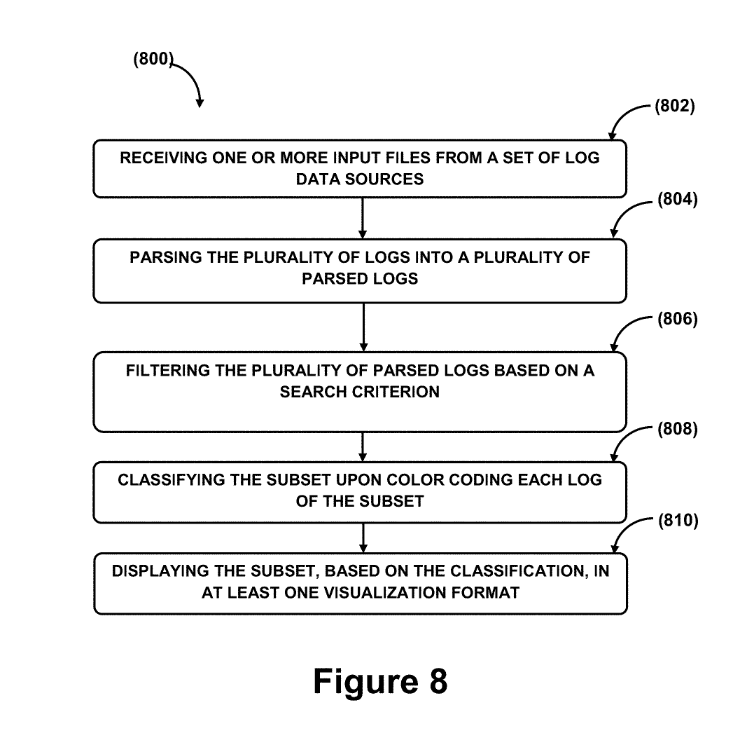

Referring now to FIG. 8, a method 800 for generating a log analysis report upon analyzing log data received from a set of log data sources is shown, in accordance with an embodiment of the present subject matter. The method 800 may be described in the general context of computer executable instructions. Generally, computer executable instructions can include routines, programs, objects, components, data structures, procedures, modules, functions, etc., that perform particular functions or implement particular abstract data types. The method 800 may also be practiced in a distributed computing environment where functions are performed by remote processing devices that are linked through a communications network. In a distributed computing environment, computer executable instructions may be located in both local and remote computer storage media, including memory storage devices.

The order in which the method 800 is described is not intended to be construed as a limitation, and any number of the described method blocks can be combined in any order to implement the method 800 or alternate methods. Additionally, individual blocks may be deleted from the method 800 without departing from the spirit and scope of the subject matter described herein. Furthermore, the method can be implemented in any suitable hardware, software, firmware, or combination thereof. However, for ease of explanation, in the embodiments described below, the method 800 may be considered to be implemented as described in the log analysis tool 102.

At block 802, one or more input files may be received from a set of log data sources. In one aspect, each input file may comprise a plurality of logs. In one implementation, the one or more input files may be received by the input module 212.

At block 804, the plurality of logs may be parsed into a plurality of parsed logs in a recursive manner. In one aspect, the plurality of logs may be parsed to merge the plurality of parsed logs in a format selected by a user. In one implementation, the plurality of logs may be parsed by the parser module 214.

At block 806, the plurality of parsed logs may be filtered based on a search criterion specified by the user. In one aspect, the plurality of parsed logs may be filtered to display a subset of the plurality of parsed logs. In one aspect, the search criterion may comprise a set of predefined parameters. In one implementation, the plurality of parsed logs may be filtered by the filtering module 216.

At block 808, the subset may be classified upon color coding each log of the subset based on one or more predefined parameters selected from the set of predefined parameters. In one implementation, the subset may be classified by the filtering module 216.

At block 810, the subset, based on the classification of the log subset, may be displayed in at least one visualization format thereby generating a log analysis report upon analyzing log data captured from the set of log data sources. In one implementation, the subset may be displayed by the output module 218.

Exemplary embodiments discussed above may provide certain advantages. Though not required to practice aspects of the disclosure, these advantages may include those provided by the following features.

Some embodiments enable a system and a method to perform drill down analysis on log data by parsing and classifying the logs.

Some embodiments enable a system and a method to display the logs based on separate fields (such as Date Time Stamp, Log Type, Severity Type) so as to make it easier for a user to analyse the logs.

Some embodiments enable a system and a method to filter the logs based on regular expressions.

Some embodiments enable a system and a method to determine all duplicate occurrences of the logs.

Some embodiments enable a system and a method to export all the logs onto an external file such as an Excel or a CSV file format.

Some embodiments enable a system and a method to remove duplicate occurrence of the messages.

Some embodiments enable a system and a method to display logs based on integrated time sequences.

Although implementations for methods and systems for generating a log analysis report upon analyzing log data received from a set of log data sources have been described in language specific to structural features and/or methods, it is to be understood that the appended claims are not necessarily limited to the specific features or methods described. Rather, the specific features and methods are disclosed as examples of implementations for generating the log analysis report.

1. A method for generating a log analysis report upon analyzing log data received from a set of log data sources, the method comprising:
receiving, by a processor, one or more input files from a set of log data sources, wherein each input file comprises a plurality of logs;
parsing, by the processor, the plurality of logs into a plurality of parsed logs in a recursive manner, wherein the plurality of logs is parsed to merge the plurality of parsed logs in a format selected by a user;
filtering, by the processor, the plurality of parsed logs based on a search criterion, specified by the user, wherein the plurality of parsed logs is filtered to display a subset of the plurality of parsed logs, and wherein the search criterion comprises a set of predefined parameters;
classifying, by the processor, the subset upon color coding each log of the subset based on one or more predefined parameters selected from the set of predefined parameters; and
displaying, by the processor, the subset, based on the classification, in at least one visualization format thereby generating a log analysis report upon analyzing log data received from the set of log data sources.

2. The method as claimed in claim 1, wherein the input file is associated to one of the file format comprising an eXtensible Mark-up Language (XML) file, a JavaScript Object Notation (JSON) file, a LOG file, and a Flat file.

3. The method as claimed in claim 1, wherein the plurality of parsed logs is further filtered based on regular expressions.

4. The method as claimed in claim 1, wherein the set of predefined parameters comprises date, message, number of occurrence, duplicate occurrences, Severity type, and file name, and wherein the severity type is one of Severe and Warning.

5. The method as claimed in claim 1, further comprising displaying metadata associated to a log selected from the subset, wherein the metadata indicates timestamp, message, source file of the log, logged date, log type, device name, and file name.

6. The method as claimed in claim 1, wherein the at least one visualization format comprises a pie chart, a bar chart, and a grid view.

7. The method as claimed in claim 1, wherein the subset is exported to at least one file format, indicating the log analysis report, upon receipt of an export request from the user.

8. A log analysis tool for generating a log analysis report upon analyzing log data received from a set of log data sources, the log analysis tool comprising:
a processor; and
a memory coupled to the processor, wherein the processor is capable of executing a plurality of modules stored in the memory, and wherein the plurality of modules comprising:
an input module for receiving one or more input files from a set of log data sources, wherein each input file comprises a plurality of logs;
a parser module for parsing the plurality of logs into a plurality of parsed logs in a recursive manner, wherein the plurality of logs is parsed to merge the plurality of parsed logs in a format selected by a user;
a filtering module for
filtering the plurality of parsed logs based on a search criterion specified by the user, wherein the plurality of parsed logs is filtered to display a subset of the plurality of parsed logs, and wherein the search criterion comprises a set of predefined parameters;
classifying the subset upon color coding each log of the subset based on one or more predefined parameters selected from the set of predefined parameters; and
an output module for displaying the subset, based on the classification, in at least one visualization format thereby generating a log analysis report upon analyzing log data captured from the set of log data sources.

9. The log analysis tool as claimed in claim 8, wherein the output module further displays metadata associated to a log selected from the subset, wherein the metadata indicates timestamp, message, source file of the log, logged date, log type, device name, and file name.

10. The log analysis tool as claimed in claim 8, further comprising an export module for exporting the subset to at least one file format, indicating the log analysis report, upon receipt of an export request from the user.

11. A non-transitory computer readable medium embodying a program executable in a computing device for generating a log analysis report upon analyzing log data received from a set of log data sources, the program comprising a program code:
a program code for receiving one or more input files from a set of log data sources, wherein each input file comprises a plurality of logs;
a program code for parsing the plurality of logs into a plurality of parsed logs in a recursive manner, wherein the plurality of logs is parsed to merge the plurality of parsed logs in a format selected by a user;
a program code for filtering the plurality of parsed logs based on a search criterion, specified by the user, wherein the plurality of parsed logs is filtered to display a subset of the plurality of parsed logs, and wherein the search criterion comprises a set of predefined parameters;
a program code for classifying the subset upon color coding each log of the subset based on one or more predefined parameters selected from the set of predefined parameters; and
a program code for displaying the subset, based on the classification, in at least one visualization format thereby generating a log analysis report upon analyzing log data captured from the set of log data sources.
